(19) United States
(12) Patent Application Publication
(10) Pub. No.: US 2014/0278934 A1
(43) Pub. Date: Sep. 18, 2014

(54) METHODS AND APPARATUS TO INTEGRATE TAGGED MEDIA IMPRESSIONS WITH PANELIST INFORMATION

(71) Applicant: Alejandro Gutierrez, Dallas, TX (US)

(72) Inventor: Alejandro Gutierrez, Dallas, TX (US)

(21) Appl. No.: 13/841,762

(22) Filed: Mar. 15, 2013

(51) Int. Cl. G06Q 30/02

(52) U.S. Cl. CPC G06Q 30/0246
USPC 705/14.45

(57) ABSTRACT

Methods, apparatus, systems and articles of manufacture are disclosed to integrate tagged media impressions with panelist information. An example method includes receiving a communication including a user agent setting. The example method also includes parsing the user agent setting for a unique identifier, and in response to finding a unique identifier, extracting the unique identifier from the user agent setting. The example method also includes identifying a panelist based on the unique identifier.

### FIELD OF THE DISCLOSURE

This disclosure relates generally to audience measurement, and, more particularly, to methods and apparatus to integrate tagged media impressions with panelist information.

### BACKGROUND

Online audience measurement of media such as Internet websites, streaming media, advertisements, etc. is typically carried out by monitoring media exposure of audience members. An impression corresponds to a home or individual having been exposed to the corresponding media (e.g., website content including audio, video, text, etc. such as an advertisement, etc.). Thus, an impression represents a home or an individual having been exposed to an advertisement or content or group of advertisements or content. In Internet advertising, a quantity of impressions or impression count is the total number of times an advertisement or advertisement campaign has been accessed by a web population.

### BRIEF DESCRIPTION OF THE DRAWINGS

FIG. 1 is a diagram of an example system constructed in accordance with the teachings of this disclosure to integrate tagged media impressions with panelist information.

FIG. 2 is a diagram of an example message path illustrating metering of tagged media.

FIG. 3 is a block diagram of the example mobile device of FIG. 1 including an on-device meter that may be used to integrate tagged media impressions with panelist information.

FIG. 4 is a block diagram of an example data collection facility of FIG. 1 that may facilitate integration of tagged media impressions with panelist information.

FIG. 5 is an example Hypertext Transfer Protocol request message that may be used to integrate tagged media impressions with panelist information.

FIG. 6 in an example data table representing online media impressions that may be stored by the example on-device meter of FIG. 1.

FIG. 7 is an example data table representing tagged media impressions that may be stored by the example data collection facility of FIG. 1.

FIG. 8 is an example data table that may be stored by the example data collection facility of FIG. 1.

FIG. 9 is an example data table representing combined media impressions collected by the on-device meter and data collection facility of FIG. 1.

FIG. 10 is a flowchart representation of example machine readable instructions that may be executed to implement the on-device meter of FIGS. 1, 2 and/or 3.

FIG. 11 is a flowchart representation of example machine readable instructions that may be executed to implement the on-device meter of FIGS. 1, 2 and/or 3.

FIG. 12 is a flowchart representation of example machine readable instructions that may be executed to implement the data collection facility of FIGS. 1, 2 and/or 4.

FIG. 13 is a flowchart representation of example machine readable instructions that may be executed to implement the data collection facility of FIGS. 1, 2 and/or 4.

FIG. 14 is a block diagram of an example processor platform that may execute, for example, the machine-readable instructions of FIGS. 10 and/or 11 to implement the example on-device meter of FIGS. 1, 2 and/or 3, and/or for executing the example machine-readable instructions of FIGS. 12 and/or 13 to implement the example data collection facility of FIGS. 1, 2 and/or 4.

### DETAILED DESCRIPTION

Example methods, systems and apparatus disclosed herein may be used to measure audience exposure and/or interaction with online media accessed by users using mobile devices. For example, techniques disclosed herein enable integrating panelist information with impressions determined from tagged media.

To enable monitoring of user access to Internet resources, in some examples, participating publishers and/or web sites insert or embed a tag within the source (e.g., Hypertext Markup Language (HTML) code) of their respective content. The tag may include Java, JavaScript and/or other executable instructions, which cause the page view to be recorded by an audience measurement entity when the tag executes on a requesting browser.

Methods, apparatus and systems for tagging media are described in, for example, U.S. Pat. No. 6,108,637, by Blumenau, entitled “Content Display Monitor,” which is hereby incorporated by reference in its entirety. Because a tag is embedded in the HTML defining a webpage and/or referenced by a pointer in the HTML of a web page, the tag is executed whenever a browser renders the corresponding media (e.g., the web page). Typically, a tag will cause the browser to send a request (or beacon) to a data collection facility associated with the audience measurement entity. In some examples, the beacon is a Hypertext Transfer Protocol (HTTP) request (e.g., an HTML GET request, an HTML POST request, etc.). The beacon enables monitoring data reflecting information about the media access to be tracked. To this end, the beacon carries identification information to be collected, compiled and/or analyzed at the data collection facility. The identification information may include a user agent string to identify a user agent with which the request is being made), the media with which the tag is associated (e.g., a media identifier such as a website address), the host (e.g., web server) with which the requested media is associated (e.g., a vendor identifier (VID)), the user device on which the media is requested, the dates/times at which the media is requested, accessed and/or received, etc.

A user agent is software that is acting on behalf of a user. A web browser is an example of a user agent. Other types of user agents include the indexing software used by search providers (e.g., web crawlers), voice browsers, mobile applications, and other software that accesses, consumed or displays web content. In many cases, a user agent acts as a client in a client-server distributed computing system. For example, the HTTP protocol identifies the user software (e.g., user agent) originating the request, even when the software is not operated by a user. In some examples, a user agent string is transmitted in a header field of an HTTP request. As a result, servers may tailor media and/or information provided in the response based on the information included in the user agent string. For example, a server may send reduced resolution images in response to an HTTP request that originated from a user agent associated with a mobile device (e.g., a smartphone). The term “user agent” is generic to both user agent and the user agent string.

Tags such as those described above may facilitate the collection of census like data. In other words, because every (or nearly every) browser that accesses the tagged webpage will respond to the tag by sending the beacon (or communication) to the data collection facility, every access to the webpage will be known by the audience measurement entity. Moreover, the collection of this data does not require the use of a special browser, or of special metering software at the user devices. Rather, because a beacon may appear to a conventional commercially available browser (e.g., Firefox, Microsoft Explorer, Google Chrome, Opera, etc.) as any other request to retrieve Internet media (e.g., as a request to obtain content or advertisement material to be displayed as part of the webpage) or transmit data, any such browser will participate in the audience measurement process without requiring modification. As a result, tagging enables collection of data from panelists and non-panelists alike. Therefore, data collected via a tagging approach such as that described above, is described herein as census data.

It is useful, however, to link demographics and/or other user information to the census data. For example, companies want to understand the reach and effectiveness of the media (e.g., advertisements) that they produce. Companies monitoring the reach and effectiveness of their media are limited to monitoring web server logs to identify requested media. Because census based data includes users who are not panelists, panelist identifiers are not collected and/or identified. Some census based systems collect impression data at the server level. Collecting information at the server level enables an accurate measure of information served by the monitored servers, but does not enable distinguishing media impressions from panelists and non-panelists. While servers may log an Internet Protocol (IP) address of a device that requested the information, IP addresses are prone to change (e.g., are dynamically assigned) and/or requests may come through proxy servers that mask the identity of the originally requesting device. Thus, server logs do not typically uniquely identify the device and/or the user making the request.

To address this issue, audience measurement entities (also referred to as “ratings entities”) traditionally determine online media reach and frequency based on registered panel members. That is, an audience measurement entity (AME) enrolls people that consent to being monitored into a panel. In such panelist based systems, demographic information is obtained from a user when, for example, the user joins and/or registers for the panel. The demographic information (e.g., race, age, income, home location, education level, gender, etc.) may be obtained from the user, for example, via a telephone interview, by having the user complete a survey (e.g., an online survey), etc. Companies such as The Nielsen Company (U.S.), LLC utilize on-device meters to monitor usage of cellphones, tablets and/or other computing devices. An on-device meter (ODM) is software that collects data of interest concerning usage of the monitored device. The ODM collects data indicating media access activities (e.g., web site names, dates/times of access, clickstream data and/or other media identifying information (e.g., webpage content, advertisements, etc.)) to which the panelist is exposed. This data is uploaded, periodically or aperiodically, to a data collection facility, such as an AME server or a data collection facility. The data collected by a meter is referred to herein as ODM data or panelist data. ODM data is advantageous in that it can be linked to demographic information because the panelist has provided their demographics as part of the registration and the activity data collected by the ODM can, thus, be associated with that demographic information.

Example methods, systems and apparatus disclosed herein modify identification information included in a beacon transmitted to a data collection facility to include a unique identifier. The unique identifier may then be used to associate the corresponding media impression with a panelist. Examples disclosed herein accomplish this by modifying a user agent included in the beacon. In some examples, an on-device meter installed on the requesting device modifies the user agent setting of a browser to include panelist identifying information (e.g., a unique identifier) associated with the panelist. For example, the on-device meter may add a panelist telephone number to the user agent setting. In the illustrated examples, when the beacon is sent to the data collection facility in response to rendering tagged media, the beacon includes the modified user agent including the unique identifier, and the impression entry logged at the data collection site includes the unique identifier.

In some examples, the logged impressions collected from the tagged media and the logged impressions collected by the on-device meter may be combined. Combining the logged impressions may be useful in supplementing the logged impressions collected from one source. For example, a beacon sent to the data collection facility may include information that the on-device meter may be unable to collect. In some such examples, the unique identifier included in the beacon facilitates extrapolating (or layering) panelist information with the logged impressions collected from the tagged media. However, combining the two logs also creates a situation where impressions may be counted twice. For example, when a panelist accesses non-tagged media via a mobile device including an ODM, the access will be logged only by the ODM. Likewise, when a non-panelist accesses tagged media, the access will be logged only at the data collection facility via the tagging mechanism mentioned above. However, when a panelist user device with a resident ODM accesses tagged media, the access will be logged by both the meter and the data collection facility, resulting in duplicate impression and/or exposure information. If the duplicate information is used when generating online audience measurement information reports (e.g., exposure statistics, demographics, etc.), the reports will over count the actual number of impressions due to the duplicates.

Example methods, systems and apparatus disclosed herein include combining panelist and non-panelist media impressions logged by the data collection facility and panelist media impressions logged by the on-device meter, identifying duplicate media impressions in the combined log, and identifying the duplicate media impressions from the combined media impressions log. Examples disclosed herein facilitate identification of duplicates by comparing impression entries collected via the tagging technique including panelist identification information from a user agent and from the on-device meter to identify duplicate impression entries. For example, the data collection facility may compare user identifiers included in the tagged content impression logs and the ODM impression logs. When two entries include similar information, one of the entries may be marked and/or discarded. In some examples, the data collection facility may also compare additional information included in the impression logs prior to marking and/or discarding an impression entry. For example, when two impression entries have the same panelist identifier and similar timestamps, requested media and/or vendor identifiers, the data collection facility may mark and/or discard one of the duplicate impression entries. In this manner, an audience measurement entity can combine media impressions for panelists and media impressions for non-panelists to obtain a more accurate impression count than obtained under previous methods.

Although examples disclosed herein are described in connection with browsers that render media, the disclosed techniques may also be used in connection with non-browser based applications used to present media.

FIG. 1 is an illustration of an example environment 100 in which examples disclosed herein may be implemented to integrate impressions of tagged media with panelist information. The example environment 100 of FIG. 1 includes an audience measurement entity (AME) 105, a media hosting server 120 and a mobile device 130. In the illustrated example, the mobile device 130 includes an on-device meter 132. In the illustrated example, the AME 105 hosts a data collection facility 110. In some examples, the data collection facility 110 is implemented using multiple devices and/or the media hosting server 120 is implemented using multiple devices. For example, the data collection facility 110 and/or the media hosting server 120 may include disk arrays or multiple workstations (e.g., desktop computers, workstation servers, laptops, etc.) in communication with one another.

In the illustrated example, the mobile device 130 is in communication with the media hosting server 120 and/or the data collection facility 110 via one or more wired and/or wireless networks represented by network 125. Example network 125 may be implemented using any suitable wired and/or wireless network(s) including, for example, one or more data buses, one or more Local Area Networks (LANs), one or more wireless LANs, one or more cellular networks, the Internet, etc. As used herein, the phrase “in communication,” including variances thereof, encompasses direct communication and/or indirect communication through one or more intermediary components and does not require direct physical (e.g., wired) communication.

In the illustrated example, the on-device meter 132 is executed by the mobile device 130 and is provided by the monitoring entity 105. In the illustrated examples, the mobile device 130 is operated by a user and may be referred to as “a user device” or a “client device.”

The example AME 105 of the illustrated example of FIG. 1 is an entity that monitors and/or reports the usage of advertisements and/or other types of media such as The Nielsen Company (US), LLC. In the illustrated example, the AME 105 is a neutral third party that does not provide content and/or advertisements to end users. This un-involvement with the content/advertisement delivery ensures the neutral status of the AME 105 and, thus, enhances the trusted nature of the data it collects. In the illustrated example, the AME 105 operates and/or hosts the data collection facility 110. The data collection facility 110 of the illustrated example is a server and/or database that collects and/or receives monitoring information related to tagged media (e.g., media having inserted or embedded executable instructions that cause the media view (e.g., impression) to be recorded by, for example, the data collection facility).

In the illustrated example of FIG. 1, a content provider and/or advertising entity operates and/or hosts the media hosting server 120 that responds to requests for media that may include tags. For example, the content provider and/or advertising entity may engage the AME 105 to collect and/or monitor information related to media associated with the content provider and/or advertising entity. Such a content provider and/or advertising entity may wish to use tagged media in a media campaign to determine the effectiveness of the media campaign. In some examples, the information returned in response to the request for media includes an instruction (e.g., tag) to inform the data collection facility 110 of the accessing of tagged media. In some examples, the web server is operated and/or hosted by a third party.

The example mobile device 130 of the illustrated example of FIG. 1 is a smartphone (e.g., an Apple® iPhone®, HTC Sensation, Blackberry Bold, etc.). However, any other type of device may additionally or alternatively be used such as, for example, a tablet (e.g., an Apple® iPad™, a Motorola™ Xoom™, a Blackberry Playbook, etc.), a laptop computer, a desktop computer, a camera, etc. In the illustrated example, the mobile device 130 is owned, leased, and/or otherwise belongs to a respective panelist and/or user. The AME 105 of the illustrated example does not provide the mobile device 130 to the panelist and/or user. In other examples, panelists are provided with a mobile device 130 to participate in the panel. In the illustrated example, the mobile device 130 is used to access online media that is tagged. In response to accessing the tagged media, media impression information, including browser identifying information, is sent to the data collection facility 110.

The on-device meter 132 of the illustrated example of FIG. 1 is software provided to the mobile device 130 by, for example, the AME 105 when or after, for example, a panelist associated with the mobile device 130 agrees to be monitored. In the example of FIG. 1, the on-device meter 132 collects monitoring information such as user-browser interaction, user-application interaction, browser identifying information, device status, user selection, user input, URL information, location information, image information, etc. and stores the monitoring information in a memory of the mobile device 130. Periodically and/or aperiodically, the on-device meter 132 transmits the monitoring information to the data collection facility 110. In the illustrated example, the on-device meter 132 may modify configuration settings of the mobile device 130. For example, the on-device meter 132 may modify a user agent setting for a browser. As a result, in some examples, HTTP requests generated by the mobile device 130 include a modified user agent as set by the on-device meter 132.

FIG. 2 is a diagram of an example message path illustrating metering of tagged media. In the illustrated example of FIG. 2, the mobile device 130 transmits a media request 202 for media to the media hosting server 120 via a browser 200. In the illustrated example, the media request 202 includes a user agent 204 identifying characteristics of the browser 200 and/or the mobile device 130. For example, the user agent 204 may include a browser identifier, a device identifier, panelist identifying information, etc. The media hosting server 120 of the illustrated example includes media (e.g., a website, an image, a video, etc.) that, when requested by the browser 200, causes the media hosting server 120 to respond with a media response 206 including a tag 208. The on-device meter 132 records the information received in the media response 206. For example, the on-device meter 132 records the website accessed (e.g., media identifier), the host of the website accessed (e.g., a vendor identifier), the user interface included in the media response 206, a timestamp for when the media response 206 was received, etc. The tagged media of the illustrated example includes executable instructions that, when requested by the browser 200, cause the browser 200 to send a communication (or beacon) including monitoring information to the data collection facility 110. The tag 208 may be included in the requested media in accordance with the teachings of Blumenau, U.S. Pat. No. 6,108,637. Accordingly, the browser 200 transmits a beacon 210 to the data collection facility 110. In some such examples, the beacon 210 is a “dummy request” in that it is not actually intended to return data. Instead it is used to carry monitoring information (e.g., panelist identifying information, the vendor identifier, the timestamp when the media was accessed, etc.) to the data collection facility 110. In some examples, the beacon 210 is implemented as an HTTP POST message, an HTTP GET message, or similar message used in present and/or future HTTP protocols. In the illustrated example, the beacon 210 includes the user agent 204 identifying the browser 200 and/or the mobile device 130. The data collection facility 110 records that a request (e.g., the beacon 210) was received and also records any data contained in the beacon 210 (e.g., the monitoring information, the user agent 204, etc.). The data collection facility 110, in some examples, responds with an acknowledgement message. In some examples, the acknowledgement message requests and/or sets a cookie in the mobile device 130 to, for example, enable identification of subsequent beacons from the mobile device from subsequent beacons.

FIG. 3 is a block diagram of an example implementation of the mobile device 130 of FIGS. 1 and/or 2 including the on-device meter 132. The mobile device 130 of the illustrated example includes a memory 305, a network communicator 310, a browser 200, a data store 345 and an on-device meter 132.

The memory 305 of the illustrated example of FIG. 3 is used by the mobile device 130 for data storage. The example memory 305 stores software applications, data and other data the mobile device 130 stores. In some examples, the memory 305 may store websites visited by the example browser 315 in a cache. In some such examples, the cache of the memory 305 includes the contents of the websites visited by the browser 315. The data stored in the memory 305 may be in any data format such as, for example, binary data, comma delimited data, tab delimited data, structured query language (SQL) structures, etc.

The network communicator 310 of the illustrated example of FIG. 3 is implemented by a cellular communicator, to allow the mobile device 130 to communicate with a cellular network (e.g., the network 125). However, additionally or alternatively, the network communicator 310 may be implemented by any other type of network interface such as, for example, an Ethernet interface, a Wi-Fi interface, a Bluetooth Interface, etc.

The browser 200 of the illustrated example of FIG. 3 is implemented by a browser capable of displaying websites and/or other Internet media (e.g., product information, advertisements, videos, images, etc.) via the mobile device 130. In the illustrated example, the browser 315 is implemented as an Android® browser. However, any other browser may additionally or alternatively be used. In the illustrated example, the browser 315 requests a resource that is hosted by the media hosting server 120 via the network communicator 310 and displays and/or renders the resource via the mobile device 130.

In the illustrated example, the browser 200 includes an example beacon generator 335. The example beacon generator 335 prepares a beacon (e.g., the example beacon 210 of FIG. 2) to send to the data collection facility 110 in response to a tag (e.g., the example tag 208 of FIG. 2) included in the response (e.g., the example media response 206). For example, the beacon generator 335 may collect the media identifier, the vendor identifier, device identifier information, etc. As described above, the beacon 210 may be a communication such as a request (e.g., an HTTP GET request, an HTTP POST request, etc.) to the data collection facility 110. Thus, the beacon 210 generated by the beacon generator 335 includes the monitoring information generated and/or collected in response to the tag 208 included in the media response 206, but also a user agent identifying the browser 200. In some examples, the beacon generator 335 may be native functionality of a browser that is activated by instructions (e.g., executable instructions received in tagged content). For example, the beacon generator 335 may be a JavaScript interpreter that executes JavaScript instructions included in or linked to content.

The example data store 345 of the illustrated example of FIG. 3 may store data in any data format such as, for example, binary data, comma delimited data, tab delimited data, structured query language (SQL) structures, etc. While in the illustrated example the data store 345 is illustrated as a single database, the data store 345 may be implemented by any number and/or type(s) of databases or data structures/devices.

In the illustrated example of FIG. 3, the on-device meter 132 (ODM) monitors the browsing history of the mobile device 130. In the illustrated example, the ODM 132 includes a user agent configurer 320, an ODM impression logger 330, a browser monitor 340, a data communicator 350 and a time stamper 355.

In the illustrated example of FIG. 3, the user agent configurer 320 configures a user agent setting of the browser 200. For example, the user agent configurer 320 appends panelist identification information to the user agent setting. In some examples, the user agent configurer 320 obtains the unique identifier from the data store 345. In some examples, the unique identifier is provided to the user agent configurer 320 and/or the data store 345 by the AME 105. For example, the AME 105 may periodically and/or aperiodically change the unique identifier for a panelist to protect user privacy. In some such examples, the AME 105 may update the unique identifier stored in the data store 345 via, for example, the data collection facility 110. As described above, the unique identifier included in the user agent enables identifying the panelist associated with the media impression (e.g., a panelist that has been identified by the ODM 132). To this end, the unique identifier is any unique system identifier that is associated with a registered panelist. For example, the panelist identification information may be an AME-generated unique ID, a phone number, a media access control address, etc.

In the illustrated example of FIG. 3, the browser monitor 340 monitors the browser 200. For example, the browser monitor 340 detects when the example browser 200 visits a website. In response to detecting a website visit, the browser monitor 340 parses or scans the returned media for monitoring information. In the illustrated example, the browser monitor 340 provides the identified monitoring information included in the media response 206 to the ODM impression logger 330.

In the illustrated example of FIG. 3, the ODM impression logger 330 credits (or logs) impressions to media based on the information provided by the browser monitor 340. For example, the ODM impression logger 330 may list media identifiers corresponding to the requested media in a data structure. In some examples, the ODM impression logger 330 appends and/or prepends additional information crediting the identified media. For example, the ODM impression logger 330 may identify a media source from which the media was received (e.g., a vendor ID, a source identifier (SID), a uniform resource locator (URL)), a network address of the mobile device 130 and/or an identifier of the mobile device 130. In some examples, the ODM impression logger 330 appends a timestamp from the time stamper 355 indicating the date and/or time at which the example on-device meter 132 received the media response. In addition, the example ODM impression logger 330 appends a panelist identifier obtained from, for example, the data store 345. In some examples, the panelist identifier is the same as the unique identifier appended to the user agent by the user agent configurer 320. In some examples, the panelist identifier is a different identifier to protect user privacy. In some such examples, the panelist identifier and the corresponding unique identifier may be stored in, for example, a lookup table or other data structure at the data collection facility 110. In some examples, the ODM impression logger 330 periodically and/or aperiodically communicates the aggregate impressions to the data collection facility 110.

In the illustrated example of FIG. 3, the data communicator 350 is implemented by an Ethernet driver that interfaces with the network communicator 310. The example data communicator 350 transmits data stored in the data store 345 to the data collection facility 110 via, for example, the network 125. While in the illustrated example, the data communicator 350 is an Ethernet driver, any other type(s) of interface may additionally or alternatively be used. For example, the data communicator 350 might include one or more of a Bluetooth interface, a Wi-Fi interface, a digital subscriber line (DSL) interface, a T1 interface, etc. While in the illustrated example a single data communicator 350 is shown, any number and/or type(s) of data communicators may additionally or alternatively be used.

The example time stamper 355 of the illustrated example includes a clock and a calendar. The example time stamper 355 associates a time period (e.g., 1:00 a.m. Central Standard Time (CST) to 1:01 a.m. CST) and a date (e.g., Jan. 1, 2013) with each generated impression entry from the ODM impression logger 330 by, for example, appending the period of time and the date information to an end of the data in the impression entry.

While an example manner of implementing the mobile device 130 of FIGS. 1 and/or 2 is illustrated in FIG. 3, one or more of the elements, processes and/or devices illustrated in FIG. 3 may be combined, divided, re-arranged, omitted, eliminated and/or implemented in any other way. Further, the example network communicator 310, the example browser 200, the example user agent configurer 320, the example ODM impression logger 330, the example beacon generator 335, the example browser monitor 340, the example data communicator 350, the example time stamper 355, the example on-device meter 132 and/or, more generally, the example mobile device 130 of FIG. 3 may be implemented by hardware, software, firmware and/or any combination of hardware, software and/or firmware. Thus, for example, any of the example network communicator 310, the example browser 315, the example user agent configurer 320, the example ODM impression logger 330, the example beacon generator 335, the example browser monitor 340, the example data communicator 350, the example time stamper 355, the example on-device meter 132 and/or, more generally, the example mobile device 130 could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example network communicator 310, the example browser 315, the example user agent configurer 320, the example ODM impression logger 330, the example beacon generator 335, the example browser monitor 340, the example data communicator 350, the example time stamper 355, the example on-device meter 132 and/or, more generally, the example mobile device 130 is/are hereby expressly defined to include a tangible computer readable storage device or storage disk such as a memory, a digital versatile disk (DVD), a compact disk (CD), a Blu-ray disk, etc. storing the software and/or firmware. Further still, the example mobile device 130 of FIGS. 1 and/or 2 may include one or more elements, processes and/or devices in addition to, or instead of, those illustrated in FIG. 3, and/or may include more than one of any or all of the illustrated elements, processes and devices.

FIG. 4 is a block diagram of an example implementation of the data collection facility 110 of FIG. 1. The example data collection facility 110 of the illustrated example includes a beacon handler 405, a user agent parser 410, a tagged impression logger 412, a panelist associator 415, an ODM data receiver 420, a data storer 425, a data store 430, a reporter 435 and a time stamper 440. In the illustrated example of FIG. 4, the beacon handler 405 receives the beacon 210 from the browser 200 of FIGS. 2 and/or 3. In some examples, the beacon handler 405 sends an acknowledgement response to the on-device meter 132 in response to receiving the beacon 210.

In the illustrated example of FIG. 4, the user agent parser 410 extracts information from the user agent included in the beacon 210 (e.g., the example user agent 204 of FIG. 2). For example, the user agent parser 410 identifies a unique identifier included in the user agent 204. In some examples, the user agent parser 410 determines a media identifier identifying the media that was received in the media response 206 of FIG. 2. In some examples, the user agent parser 410 identifies a vendor identifier, a browser identifier, a device identifier, etc. In some examples, the user agent parser 410 may be unable to identify a unique identifier in the user agent 204. For example, when the beacon 210 is sent from a non-panelist mobile device, the user agent will not have been modified to include a unique identifier.

In the illustrated example of FIG. 4, the tagged impression logger 412 credits (or logs) impressions to media based on the monitoring information included in the beacon 210. For example, the tagged impression logger 412 may list the corresponding media (e.g., via media identifiers) in a data structure. In some examples, the tagged impression logger 412 appends and/or prepends additional information crediting the identified media. For example, the tagged impression logger 412 may identify a media source from which the media was received (e.g., a vendor ID, a source identifier (SID), a uniform resource locator (URL)), a network address of the mobile device 130 and/or an identifier of the mobile device 130. In addition, the tagged impression logger 412 may append a timestamp from the time stamper 440 indicating the data and/or time when the media was received by the data collection facility 110.

Using the unique identifier extracted by the user agent parser 410, the example panelist associator 415 of the illustrated example determines that the unique identifier corresponds to a registered panelist. In some examples, the panelist associator 415 may use a lookup table to determine the registered panelist to whom the unique identifier corresponds. However, other methods to determine the registered panelist may additionally or alternatively be used. In some examples, the panelist associator 415 may append the registered panelist information to the corresponding media impression logged by the tagged impression logger 412.

In some examples, the panelist associator 415 may be unable to associate a unique identifier with a registered panelist. In some other examples, the user agent parser 410 may not provide panelist identification information. In some such examples, the panelist associator 415 attributes this to a non-panelist media impression and associates the monitoring information included in the beacon 210 as census data. Accordingly, the panelist associator 415 may append a label indicating census data to the corresponding media impression logged by the tagged impression logger 412.

As previously described, periodically and/or aperiodically, the on-device meter 132 of the mobile device 130 transmits monitoring information to the data collection facility 110. The example ODM data receiver 420 of the illustrated example receives the monitoring information from the on-device meter 132. In some examples, the monitoring information is transmitted via, for example, the Internet. However, in some examples, the monitoring information is physically transported (e.g., via a storage device such as a flash drive, magnetic storage media, optical storage media, etc.) to a location of the data collection facility 110. Typically, the data collection facility 110 will receive data from many user devices (e.g., panelists and/or non-panelists). In some examples, the ODM impression logger 330 may not credit (or log) impressions to media. For example, the ODM impression logger 330 may ignore or discard monitoring information when, for example, the on-device meter 130 includes the user agent configurer 320. Additionally or alternatively, the ODM impression logger 330 may not credit impressions to media when the requested media is known to include a tag. For example, the ODM impression logger 330 may use a lookup table to determine that the media requested by the browser 200 is tagged. In some such examples, the on-device meter 132 may not transmit monitoring information or may transmit limited monitoring information to the data collection facility 110.

In the illustrated example of the FIG. 4, the example data storer 425 stores monitoring information received from the user agent parser 410, the panelist association information via the panelist associator 415 and/or monitoring information received via the ODM data receiver 420.

The example data store 430 of the illustrated example of FIG. 4 may be implemented by any storage device and/or storage disc for storing data such as, for example, flash memory, magnetic media, optical media, etc. Furthermore, the data stored in the data store 430 may be in any data format such as, for example, binary data, comma delimited data, tab delimited data, structured query language (SQL) structures, etc. While in the illustrated example the data store 430 is illustrated as a single database, the data store 430 may be implemented by any number and/or type(s) of databases.

In some examples, the received monitoring information from the tagging system and the on-device meter are combined into, for example, a joint data structure. In some such examples, duplicate entries may be included. For example, when a panelist accesses tagged media via a mobile device having an on-device meter, the media impression is logged by the ODM impression logger 330 and by the tagged impression logger 412, resulting in storing duplicate exposure information.

To address duplicate entries, the illustrated example of FIG. 4 includes a duplicate identifier 432. In the illustrated example, the duplicate identifier 432 compares the entries from the ODM impression logger 330 and the tagged impression logger 412. For example, the duplicate identifier 432 may sort the impression entries based on the panelist identification information field (e.g., panelist identifiers, unique identifiers). In addition, the example duplicate identifier 432 may compare additional monitoring information included in the impression entries. For example, if an impression entry from the ODM impression logger 330 and an impression entry from the tagged impression logger 412 are both associated with the same panelist and both entries include the same media identifier, the same vendor identifier and/or similar timestamps, the example duplicate identifier 432 may flag one of the entries as a duplicate. For example, when duplicate entries are identified, the duplicate identifier 432 may determine which of the two entries includes less monitoring information and flag that impression entry. In some examples, the duplicate identifier 432 may flag impression entries from the ODM impression logger 330 when duplicate entries are identified by the duplicate identifier 432. For example, monitoring information included in a beacon 210 may be more robust than monitoring information collected by the on-device meter 132. For example, a beacon 210 may include referrer information, while the on-device meter 132 may be unable to detect the referred information. Alternatively, the example duplicate identifier 432 may flag impression entries from the tagged impression logger 412 when duplicate entries are identified by the duplicate identifier 432. In some examples, flagged entries are periodically (e.g., once a day, etc.) and/or aperiodically (e.g., when the reporter 435 is generating a report) discarded. In some examples, the duplicate identifier 432 may merge the data included in the duplicate impression entries into a single impression entry.

In the illustrated example of FIG. 4, the reporter 435 generates reports based on the received monitoring information. In some examples, the reports are presented to the content provider and/or advertising entity and/or other entities. The reports may identify different aspects of the media such as, for example, how many impressions the media received and demographics information associated with those impressions. In some examples, when the reporter 435 is calculating total impressions information, the reporter 435 may not include the flagged entries in the total impressions count.

The example time stamper 440 of the illustrated example includes a clock and a calendar. The example time stamper 440 associates a time period (e.g., 1:00 a.m. Central Standard Time (CST) to 1:01 a.m. CST) and a date (e.g., Jan. 1, 2013) with each generated tagged impression entry from the tagged impression logger 412 by, for example, appending the period of time and the date information to an end of the data in the impression entry.

While an example manner of implementing the data collection facility 120 of FIGS. 1 and/or 2 is illustrated in FIG. 4, one or more of the elements, processes and/or devices illustrated in FIG. 4 may be combined, divided, re-arranged, omitted, eliminated and/or implemented in any other way. Further, the example beacon handler 405, the example user agent parser 410, the example tagged impression logger 412, the example panelist associator 415, the example ODM data receiver 420, the example data storer 425, the example duplicate identifier 432, the example reporter 435, the example time stamper 440 and/or, more generally, the example data collection facility 110 of FIG. 4 may be implemented by hardware, software, firmware and/or any combination of hardware, software and/or firmware. Thus, for example, any of the example beacon handler 405, the example user agent parser 410, the example tagged impression logger 412, the example panelist associator 415, the example ODM data receiver 420, the example data storer 425, the example duplicate identifier 432, the example reporter 435, the example time stamper 440 and/or, more generally, the example data collection facility 110 of FIG. 4 could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example beacon handler 405, the example user agent parser 410, the example tagged impression logger 412, the example panelist associator 415, the example ODM data receiver 420, the example data storer 425, the example duplicate identifier 432, the example reporter 435, the example time stamper 440 and/or, more generally, the example data collection facility 110 of FIG. 4 is/are hereby expressly defined to include a tangible computer readable storage device or storage disk such as a memory, a digital versatile disk (DVD), a compact disk (CD), a Blu-ray disk, etc. storing the software and/or firmware. Further still, the example data collection facility 110 of FIGS. 1 and/or 2 may include one or more elements, processes and/or devices in addition to, or instead of, those illustrated in FIG. 4, and/or may include more than one of any or all of the illustrated elements, processes and devices.

FIG. 5 illustrates an example beacon 500 that has been sent by a browser in which the user agent setting of the browser has been modified to include a unique identifier in the user agent field. In the illustrated example of FIG. 5, the beacon 500 includes an example beacon request line 502 and example headers 504. In the illustrated example, the beacon request line 502 indicates that the beacon 500 is an HTTP GET request. However, other HTTP requests such as an HTTP POST request and/or an HTTP HEAD request are also possible. In the illustrated example of FIG. 5, the example beacon request line 502 includes a request for a resource (e.g., /tagging_instruction_location.pl?id=1025491) from the server (e.g., www.monitoring.entity.com). As described above in connection with the message path implementing a tagging approach of FIG. 2, the beacon 500 requests a resource from the data collection facility 110.

In the illustrated example of FIG. 5, the beacon headers 504 include the example user agent 200. The example user agent 200 identifies characteristics of the user agent (e.g., the example browser 200 of FIGS. 2 and/or 3). In the illustrated example of FIG. 5, the user agent 200 indicates that the beacon 500 was sent via a version 5.0 Mozilla browser. In addition, the example user agent 200 includes the example unique identifier 212. The example unique identifier 212 may be any unique system identifier that is associated with a registered panelist. For example, the unique identifier 212 may be a panelist telephone number, an audience measurement entity generated identifier, a telephone number, a media access control (MAC) address, etc.

FIG. 6 illustrates an example data table 600 representing online media impressions that may be stored by the example on-device meter 132 of FIG. 1 in the example data store 345 of FIG. 3 and/or the data store 430 of FIG. 4. The example data table 600 identifies a panelist identifier 602, a timestamp of the request 604, and a requested website 606. In some examples the data table 600 may include additional monitoring information such as a vendor identifier (e.g., the person/entity to which the website 606 is registered), a mobile device 130 identifier (e.g., an Internet protocol (IP) address), etc. For example, row 620 indicates that a user associated with the panelist ID “10001” requested the website “HostingServer1.com” at 8:00 AM on Jan. 1, 2013.

In the illustrated example of FIG. 6, the data table 600 represents the online media impressions collected by the on-device meter 132 of the mobile device 130. Thus, the panelist identifier 602 is the same for the three impression entries 620, 622, 624. In some examples, the on-device meter 132 periodically and/or aperiodically transmits the collected monitoring information (e.g., the information included in the data table 600) to the data collection facility 110. In some examples, the example data collection facility 110 may receive monitoring information from a number of on-device meters 132. As a result, the panelist identifier column 602 may include additional panelist identifiers.

FIG. 7 is an example data table 700 representing tagged media impressions that may be stored by the example data collection facility 110 of FIG. 1. In the illustrated example of FIG. 7, the data table 700 identifies a unique identifier 702, a timestamp of the request 704, a requested website 706 and a reported user agent 708. In the illustrated example, the data collection facility 110 extracts the unique identifier from the reported user agent when the reported user agent includes the information. Similar to the information included in the example data table 600 of FIG. 6, the example data table 700 of FIG. 7 includes a website requested (e.g., the website column 706) and a timestamp of the request (e.g., the timestamp column 704). For example, row 722 indicates that a user associated with the unique identifier 6481239875 requested the website “HostingServer2.com” at 9:15 AM on Jan. 2, 2013. In addition to the information included in those columns, the data table 700 includes a reported user agent column 708. The example user agent column 708 identifies characteristics of the user agent that initiated the media request. However, some user agents may not include a unique identifier. For example, in row 726, the user who accessed the website “HostingServer2.com” was not a registered panelist. Thus, a unique identifier is not included in row 726.

FIG. 8 is an example data table 800 that may be stored by the example data collection facility 110 of FIG. 1 to instruct the data collection facility 110 on how to associate unique identifiers included in the tagged media impression logs with panelist information. In the illustrated example of FIG. 8, the data table 800 associates a panelist identifier 802 with a unique identifier 804. For example, in row 820, the panelist identifier “10001” is the same registered panelist associated with the unique identifier “6481239875.” In addition, the example data table 800 includes demographic information associated with the panelists. Thus, for example, in row 824, a registered panelist with the panelist identifier “30709” is also associated with the unique identifier “BgHddMr7r,” is a female between the ages of 35 and 39, and lives in Oakland. In some examples, the data table 800 may include more demographic information associated with the panelists such as, for example, race, income, level of education completed, occupation, relationship status, etc. By using different identifiers for the tagged media system and the on-device metering system, user privacy of the panelist is protected. For example, personally-identifying information is not revealed while transmitting information (e.g., the monitoring information) to the data collection facility 110 and/or the mobile device 130. In some examples, the panelist identifiers and/or the unique identifiers may be encrypted.

FIG. 9 is an example data table 900 representing combined media impressions collected by the on-device meter 132 and data collection facility 110 of FIG. 1. In the illustrated example of FIG. 9, the data table 900 is an aggregate table including the media impressions from the example data table 600 and the example data table 700. For example, row 920 of FIG. 9 corresponds to row 620 of FIG. 6. In the illustrated example, the example data table 900 identifies whether the impression was credited via panelist or census data 902 (e.g., whether the data corresponds to activity of a panelist or a non-panelist), a panelist identifier 904, a unique identifier 906, a timestamp of the media request 908, a requested website 910 and a reported user agent 912.

In the illustrated example, identifying whether the exposure was monitored via panelist data or census data 902 may be beneficial for analysis purposes. Census data includes data monitored using the data collection facility 110 and/or the web server 120. The data collection facility 110 and/or the web server 120 may not be aware of whether the requesting device employs the on-device meter 132. Accordingly, there is limited opportunity to, at the time of receiving a request, identify whether or not the request is associated with a panelist. Accordingly, census data includes information pertaining to panelists and non-panelists alike. On the other hand, panelist data is recorded using an on-device meter (e.g., the example on-device meter 132). Identifying whether the exposure and/or impression was monitored via panelist or census data may enable reduction of double counted exposures (e.g., when an exposure is monitored by both the panelist system and the census system). Double counted exposures represent an overlap between the census data and the panelist data. For example, a mobile device 130 having an on-device meter 132 may store monitoring information included in the media response 206 of FIG. 2 received from the media hosting server 120. Rendering the media included in the media response 206 may also cause the monitoring information to be recorded by the data collection facility 110.

In the illustrated example, double counted impressions are identified using, for example, the panelist identifier 904 and/or the unique identifier 906 in combination with the timestamp 908, the requested website 910, whether the impression was monitored via panelist or census data 902, etc. For example, row 924 indicates that media requested from “HostingServer2.com” was requested on Jan. 2, 2013 at 9:15 AM by a panelist associated with the panelist identifier 10001 (and/or the unique identifier 906) that used panelist based measurement. Row 926 indicates that media requested from “HostingServer2.com” was also requested on Jan. 2, 2013 at 9:15 AM by a panelist associated with the panelist identifier 10001 (and/or the unique identifier 9060) that used panelist based measurement. In some examples, the data collection facility 110 identifies that since media was requested from the same website (e.g., “HostingServer2.com”) at the same time by the same panelist, that the impression (of rows 924 and 926) has been recorded multiple times. In the illustrated example of FIG. 9, the data collection facility 110 marks at least one of the duplicate impressions. For example, the data collection facility 110 may flag the impression entry that includes the least amount of additional information. For example, while the rows 920 and 922 correspond to the same media request by the panelist (e.g., a media request from HostingServer1.com), the information included in row 922 includes additional information such as a reported user agent 912. In some such examples, the data collection facility 110 may set a flag 914 for row 920. In some examples, the data collection facility 110 may periodically and/or aperiodically discard impressions that are marked with a flag 914. In some examples, when the data collection facility 110 is calculating a total impression count for media, the data collection facility 110 may skip the impressions that are marked with a flag 914. In this manner, the audience measurement entity 105 of FIG. 1 can combine media impressions for panelists and media impressions for non-panelists to obtain a more accurate impression count than obtained under previous methods.

The panelist identifier 904 and/or the unique identifier 906 of the illustrated example of FIG. 9 identifies the panelist that requested the media. While in the illustrated example a panelist identifier (or unique identifier) is used, any other information that may be used to identify the panelist may additionally or alternatively be used such as, for example, a mobile device identifier, a panelist name, a cookie, etc. While in the illustrated example the requested website 910 is used, any additional or alternative information may be used to identify the media that was requested such as, for example, the vendor identifier, the tag encoded in the media response 206, etc.

The timestamp column 908 of the illustrated example of FIG. 9 represents a time when information associated with the media (e.g., a website) was requested. However, the timestamp column 908 may alternatively represent a time when the requested media was rendered (e.g., displayed, presented, etc.) by the mobile device 130. Storing a timestamp (e.g., date and/or time) enables analysis of when users request particular media (e.g., are users more likely to request media from a news website (e.g., www.cnn.com) on a weekend, during a weekday, etc.).

Flowcharts representative of example machine readable instructions for implementing the on-device meter 132 of FIGS. 1, 2 and/or 3 are shown in FIGS. 10 and 11. Flowcharts representative of example machine readable instructions for implementing the data collection facility 110 of FIGS. 1, 2 and/or 4 are shown in FIGS. 12 and 13. In these examples, the machine readable instructions comprise a program for execution by a processor such as the processor 1412 shown in the example processor platform 1400 discussed below in connection with FIG. 14. The program may be embodied in software stored on a tangible computer readable storage medium such as a CD-ROM, a floppy disk, a hard drive, a digital versatile disk (DVD), a Blu-ray disk, or a memory associated with the processor 1412, but the entire program and/or parts thereof could alternatively be executed by a device other than the processor 1412 and/or embodied in firmware or dedicated hardware. Further, although the example program is described with reference to the flowchart illustrated in FIGS. 10-13, many other methods of implementing the example on-device meter 132 and/or the example data collection facility 110 may alternatively be used. For example, the order of execution of the blocks may be changed, and/or some of the blocks described may be changed, eliminated, or combined.

As mentioned above, the example processes of FIGS. 10-13 may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals. As used herein, “tangible computer readable storage medium” and “tangible machine readable storage medium” are used interchangeably. Additionally or alternatively, the example processes of FIGS. 10-13 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable device or disk and to exclude propagating signals. As used herein, when the phrase “at least” is used as the transition term in a preamble of a claim, it is open-ended in the same manner as the term “comprising” is open ended.

The program of FIG. 10 begins at block 1000 at which the on-device meter 132 is initiated. For example, the on-device meter 132 may be initiated upon installation in the mobile device 130, when it receives a unique identifier from the data collection facility 110, when usage of the mobile device 130 is detected, etc. At block 1002, the user agent configurer 320 (FIG. 3) obtains a unique identifier. For example, the user agent configurer 320 of the on-device meter 132 obtains the unique identifier from the data store 345 (FIG. 3). In some examples, the audience measurement entity 105 and/or the data collection facility 110 of FIG. 1 may provide the unique identifier to the on-device meter 132 to store in the data store 345.

At block 1004, the user agent configurer 320 modifies the user agent setting of the browser 200 to include the unique identifier. For example, the user agent configurer 320 may append the unique identifier to the user agent setting of the browser 200. As a result, network communications originating from the mobile device 130 (FIG. 3) include the modified unique identifier. That is, network requests such as HTTP GET requests, HTTP POST requests, etc. sent to servers (e.g., the data collection facility 110) by the mobile device 130 include this uniquely identifying information. The example process 1000 of FIG. 10 then ends.

The program of FIG. 11 begins at block 1102 at which the example on-device meter 132 identifies monitoring information to record. For example, the browser monitor 340 scans the content of the media response 206 received in response to the media request 202 from the media hosting server 120. For example, the browser monitor 340 may identify the requested media, the vendor (e.g., the media owner), etc. included in the media response 206.

At block 1104, the ODM impression logger 330 records the media impression. For example, the ODM impression logger 330 credits (or logs) impressions to requested media based on the monitoring information provided by the browser monitor 340. In some examples, the ODM impression logger 330 stores the impression entry in the data store 345.

At block 1106, the time stamper 355 associates a time period (e.g., 1:00 AM Central Standard Time (CST) to 1:01 AM CST) and date (e.g., Jan. 1, 2013) with the logged impression. For example, the time stamper 355 appends the period of time and date information to an end of the impression entry in the data store 345.

At block 1108, the on-device meter 132 transmits the recorded media impression(s) information to the data collection facility 110. For example, the on-device meter 132 periodically and/or a periodically transmits the recorded media impression(s) to the data collection facility 110. The program 1100 of FIG. 11 then ends.

The program of FIG. 12 begins at block 1202 at which the data collection facility 110 receives the beacon 210 from the on-device meter 132 in response to the tag 208 included in the media response 206. For example, the beacon handler 405 (FIG. 4) receives the beacon 210. In some examples, the beacon handler 405 transmits an acknowledgement response to the on-device meter 132 in response to the beacon 210. In some examples, the beacon handler 405 may transmit a request to the on-device meter 132 to provide additional information, set a cookie, etc.

At block 1204, the user agent parser 410 parses the user agent 204 included in the beacon 210 for a unique identifier. When a unique identifier is found (block 1206), the user agent parser 410 provides the unique identifier to the panelist associator 415 to determine the registered panelist to whom the unique identifier corresponds (block 1208). Otherwise, when a unique identifier is not found (block 1206), control proceeds to block 1210.

At block 1210, the tagged impression logger 412 stores a record of the monitored information provided by the beacon 210. For example, the user agent parser 410 extracts a requested media identifier (e.g., a URL address), a vendor identifier, etc. that may be included in the header and/or body of the beacon 210.

At block 1212, the time stamper 440 associates a time period (e.g., 1:00 AM Central Standard Time (CST) to 1:01 AM CST) and date (e.g., Jan. 1, 2013) with the tagged media impression. For example, the time stamper 440 appends the period of time and date information to an end of the impression entry in the data store 430 and/or provides the period of time and date information to the data storer 425. The example process 1200 of FIG. 12 then ends.

The program of FIG. 13 begins at block 1302 at which the reporter 435 prepares the tagged media impressions log to be combined with the ODM media impression log. For example, the reporter 435 may associate a panelist identifier with the unique identifier included in the tagged media impression. For example, the reporter 435 may utilize a data structure such as the example data table 800 of FIG. 8 to associate the unique identifier to a panelist identifier. Similarly, at block 1304, the reporter 440 prepares the ODM impression log for combining with the tagged media impressions log. For example, the reporter 435 may utilize the data table 800 to associate the panelist identifier with the unique identifier.

At block 1306, the reporter 435 combines the two logs. In some examples, the reporter 435 sorts the entries using, for example, the timestamp associated with each entry. For example, the data table 900 of FIG. 9 is an example representation of a combined log that is sorted based on timestamps. Because the on-device meter 132 records media requests (e.g., in the data table 600) and the data collection facility 110 records tagged media requests (e.g., in the data table 700), some impressions are included twice. Thus, at block 1308, the reporter 435 scans the combined log 900 for duplicate impressions. For example, the reporter 435 may traverse the combined log 900 comparing the panelist identifiers. When two impressions with the same panelist identifiers are identified (block 1308), the reporter 435 determines whether additional fields for the identified impression are similar (block 1310). When additional fields for the identified impressions include similar fields (block 1310), the reporter 435 marks one of the entries as a duplicate entry. For example, two impressions may have the same panelist identifier and may have requested the same media at substantially the same time. In such examples, the reporter 435 may set a flag (e.g., the example flag 914 of FIG. 9). Control then proceeds to block 1314 at which the reporter 435 checks if there are additional impressions in the combined log 900.

In contrast, at block 1310, when the reporter 435 does not find additional similar fields in the two identified impressions, control proceeds to block 1314 and the reporter 435 checks if there are additional impressions in the combined log. Similarly, at block 1308, when impressions with the same panelist identifier are not found, control proceeds to block 1304 and the reporter 435 checks if there are additional impressions in the combined log. When the reporter 435 is not at the end of the combined log 900 (block 1314), control returns to block 1304 and the reporter 435 continues checking the combined log 900 for duplicate entries. When the reporter 435 is at the end of the combined log 900 and there are no additional impressions to check (block 1314), the reporter 435 generates a report (block 1316) and the process 1300 of FIG. 13 ends.

FIG. 14 is a block diagram of an example processor platform 1400 capable of executing the instructions of FIGS. 10 and/or 11 to implement the on-device meter 132 of FIGS. 1, 2 and/or 3, and/or the instructions of FIGS. 12 and/or 13 to implement the example data collection facility 110 of FIGS. 1, 2 and/or 4. The processor platform 1400 can be, for example, a server, a personal computer, a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, or any other type of computing device.

The processor platform 1400 of the illustrated example includes a processor 1412. The processor 1012 of the illustrated example is hardware. For example, the processor 1412 can be implemented by one or more integrated circuits, logic circuits, microprocessors or controllers from any desired family or manufacturer.

The processor 1412 of the illustrated example includes a local memory 1413 (e.g., a cache). The processor 1412 of the illustrated example is in communication with a main memory including a volatile memory 1414 and a non-volatile memory 1416 via a bus 1418. The volatile memory 1414 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 1416 may be implemented by flash memory and/or any other desired type of memory device. Access to the main memory 1414, 1416 is controlled by a memory controller.

The processor platform 1400 of the illustrated example also includes an interface circuit 1420. The interface circuit 1420 may be implemented by any type of interface standard, such as an Ethernet interface, a universal serial bus (USB), and/or a PCI express interface.

In the illustrated example, one or more input devices 1422 are connected to the interface circuit 1420. The input device(s) 1422 permit(s) a user to enter data and commands into the processor 1412. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 1424 are also connected to the interface circuit 1420 of the illustrated example. The output devices 1424 can be implemented, for example, by display devices (e.g., a light emitting diode (LED), an organic light emitting diode (OLED), a liquid crystal display, a cathode ray tube display (CRT), a touchscreen, a tactile output device, a light emitting diode (LED), a printer and/or speakers). The interface circuit 1420 of the illustrated example, thus, typically includes a graphics driver card, a graphics driver chip or a graphics driver processor.

The interface circuit 1420 of the illustrated example also includes a communication device such as a transmitter, a receiver, a transceiver, a modem and/or network interface card to facilitate exchange of data with external machines (e.g., computing devices of any kind) via a network 1426 (e.g., an Ethernet connection, a digital subscriber line (DSL), a telephone line, coaxial cable, a cellular telephone system, etc.).

The processor platform 1400 of the illustrated example also includes one or more mass storage devices 1428 for storing software and/or data. Examples of such mass storage devices 1428 include floppy disk drives, hard drive disks, compact disk drives, Blu-ray disk drives, RAID systems, and digital versatile disk (DVD) drives.

The coded instructions 1432 of FIGS. 10-13 may be stored in the mass storage device 1428, in the volatile memory 1414, in the non-volatile memory 1416, and/or on a removable tangible computer readable storage medium such as a CD or DVD.

Example methods, apparatus and articles of manufacture have been disclosed which enable integrating tagged media impressions with panelist information, and, thereby, enable correlating demographic information with the census based information.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. A method comprising:
receiving a communication including a user agent setting;
parsing the user agent setting for a unique identifier;
in response to finding the unique identifier, extracting the unique identifier from the user agent setting; and
identifying a panelist based on the unique identifier.

2. A method as defined in claim 1, wherein the communication includes monitoring information corresponding to accessed media.

3. A method as defined in claim 2, further comprising associating the panelist with the monitoring information.

4. A method as defined in claim 1, wherein the unique identifier is a panelist identifier.

5. A method as defined in claim 1, wherein the unique identifier is a telephone number.

6. A method as defined in claim 1, wherein the unique identifier is a media access control address.

7. A method as defined in claim 1, wherein the communication is a hypertext transfer protocol get request.

8. A method as defined in claim 1, wherein the communication is a hypertext transfer protocol post request.
